(19) United States
(12) Patent Application Publication
(10) Pub. No.: US 2007/0023117 A1
(43) Pub. Date: Feb. 1, 2007

(54) Tyre with pivotable ground pads

(75) Inventor: Hugh Rogers McLaughlin, Blackrock Co (IE)

Correspondence Address: BURNS & LEVINSON, LLP;(FORMERLY PERKINS SMITH & COHEN LLP), 125 SUMMER STREET, BOSTON, MA, 02110, US

(73) Assignee: SEAMUS McLAUGHLIN, Fermanagh (GB)

(21) Appl. No.: 11/189,893

(22) Filed: Jul. 26, 2005

(51) Int. Cl. B60C 11/00

(52) U.S. Cl. 152/169

(57) ABSTRACT

A pivotable ground pad tyre includes a tyre for mounting on a vehicle wheel and a plurality of ground-engaging pads disposed around the circumference of the tyre. Each pad is capable of at lease a limited angle of rotational displacement about a substantially radial axis R of the tyre such that the tyre may turn through the limited angle of rotation relative to any pad currently in ground contact, each pad being returned resiliently to its undisplaced position when the pad has moved out of contact with the ground. The pads are pre-mounted on at least one resilient strip which is secured around the circumference of the tyre.

### FIELD OF THE INVENTION

The present invention relates to tyres for machines that normally require wide faced treads for the purpose of spreading the load carried over grass covered ground or other soft surfaces, for example, golf fairways, and in particular, non-removeable pivotable ground engagement pads secured to a circumference of a tyre.

### BACKGROUND OF THE INVENTION

The vehicle tyres used on, for example, golf carts and grass mowing machines usually have a conventional pneumatic tyre and the overall diameter of the vehicle wheel and tyre is approximately eighteen (18) inches, the tyre having a curved ground engaging surface of approximately eight (8) inches in width. The width of the tyre is necessarily restricted since the wider the tyre is, then the greater is the scourging effect on the ground when the vehicle wheel is turning. The scourging of the ground is caused by the tyre when turning as the outer part of the tyre must effectively rotate faster than the inner part, since the former has in effect to travel a greater distance. Since the outer part of the tyre cannot rotate faster than the inner part, the tyre skids and this skidding scourges the ground surface. However, even a tyre having a width of eight (8) inches substantially scourges the ground when turning. This is particularly the case on golf fairways. The scourging of the ground is accentuated by the weight which the tyre carries and which is exerted on the ground surface.

U.S. Pat. Nos. 4,759,638 and 5,004,030, both by McLaughlin and both incorporated herein by reference, describes a tyre with pivotable, load-spreading ground-engaging pads for use on grass-covered ground or other soft surfaces. The pads disclosed in these patents are removable attached to the circumference of the tyre individually by studs or spindles that extend through the outer wall or circumferential of the tyre. However, this design is a complex construction that is time-consuming and expensive to manufacture and assembly. Also, since the studs or spindles extend through the walls of the tyre, the tyres are more prone to pressure leaks and failure than standard tyres.

### SUMMARY OF THE INVENTION

It is an object of the invention to provide a pivotal ground pad tyre that is simple and inexpensive to manufacture and assembly.

It is another object of the present invention to provide a pivotal ground pad tyre that maintains the internal pressure integrity of the tyre by eliminating the attachment of pivotal ground-engaging pads to the tyre by piercing or punchering the outer circumference of the tyre.

According to an aspect of the present invention there is provided a tyre comprising an inflatable annular convention tire for mounting on a vehicle wheel and a plurality of ground-engaging pads disposed around the circumference of the tire, each pad being capable of at least a limited angle of rotational displacement about a substantially radial axis of the tube such that the tube may turn through the limited angle of rotation relative to any pad currently in ground contact, each pad being returned resiliently to its undisplaced position when the pad has moved out of contact with the ground, wherein the pads are non-removably mounted on at least one resilient strip which is secured around the circumference of the inflatable tire.

The invention is also directed to a method by which the described apparatus operates and including method steps for carrying out every function of the apparatus.

### BRIEF DESCRIPTION OF THE DRAWINGS

An embodiment of the invention will now be described, by way of example only, with reference to the accompanying drawings, in which:

FIG. 1 is a perspective view of an embodiment of tyre according to the present invention;

FIG. 2 is a side view of the tyre of FIG. 1;

FIG. 3 is a perspective top view of a set of strip-mounted pads prior to mounting on the inflatable tube;

FIG. 3A is a plan view of the pads as the wheel experiences a turning motion;

FIG. 4 is a perspective bottom view of the set of strip-mounted pads of FIG. 3; and

FIG. 5 is a cross-section of the tyre taken on the line V-V of FIG. 1.

### DETAILED DESCRIPTION OF THE INVENTION

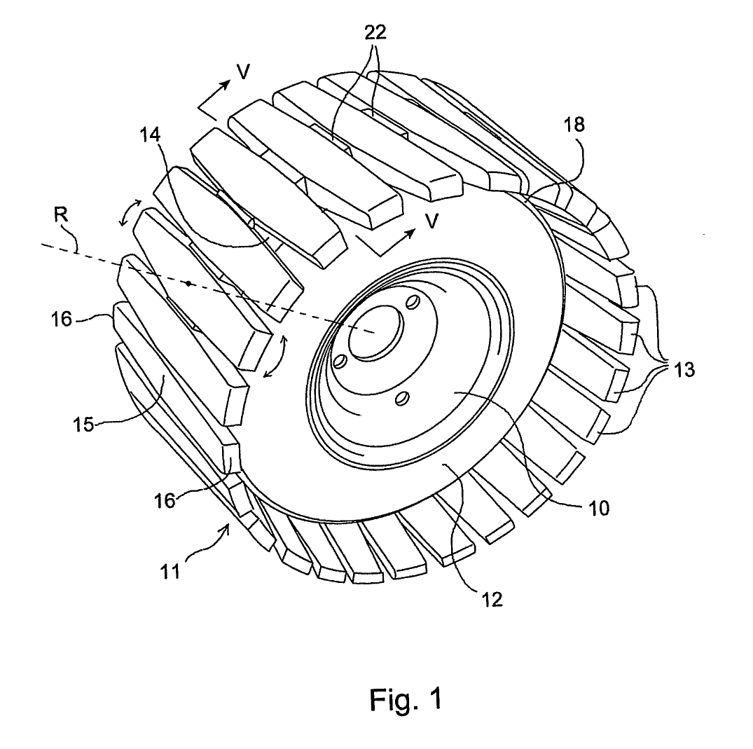

Referring now to the FIGS. 1, 2, 3, 4 and 5, one embodiment of the pivotable ground pads tyre 11 includes a tyre 12 (preferably a pneumatic tyre) and a ground engagement pad assembly 41 to couple a plurality of ground engagement pads 13 to a circumference 14 of tyre 12 without piercing the walls or circumference 14 of tyre 12. Tyre 12 is adapted for mounting to a conventional wheel 10.

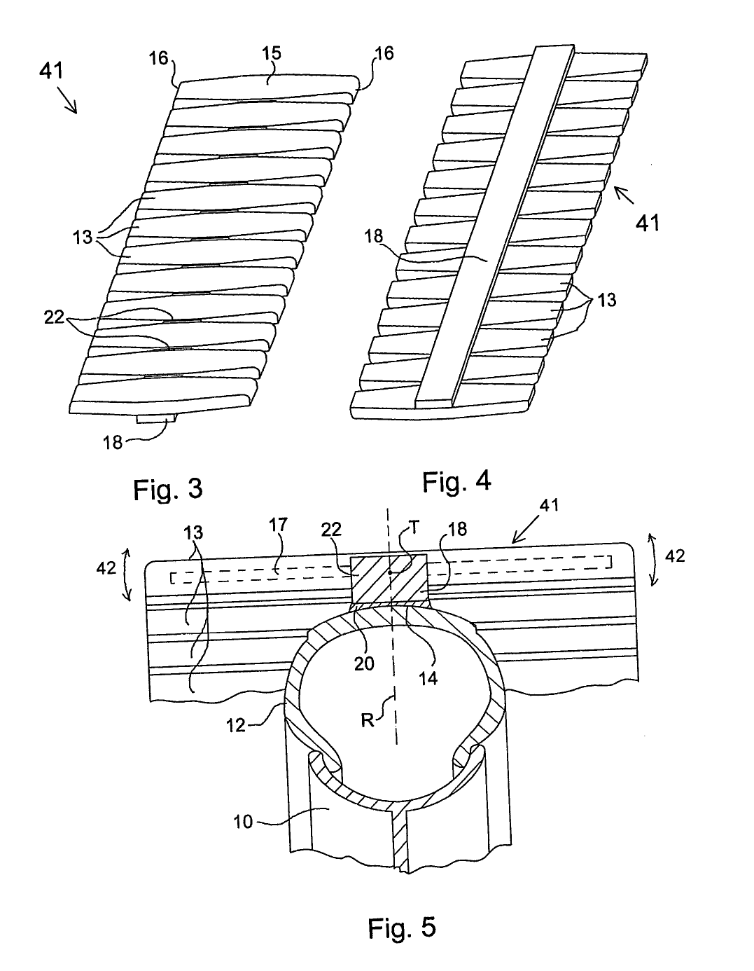

One embodiment of ground engagement pad assembly 41 includes a resilient strip 18 with pads 13 mounted thereto as illustrated in FIGS. 3 and 4. Pads 13 are pre-mounted along and transverse to resilient strip 18 of, for example, natural or synthetic rubber or other suitable polymers. Each pad 13 is elongated in a direction substantially parallel to the rotational axis of tyre 12. Typically each pad 13 has a length of approximately fourteen inches and a maximum width of approximately five inches in the circumferential direction of the tyre. Pads 13 are adjacently positioned and slightly spaced apart. Pads 13 can be tapered slightly inward from their widest central part 15 towards their narrowest ends 16. Depending on the requirements or use of the present invention 11, the dimensions of pads 13 and tyre 12, and the number of pads 13 can vary as appropriate. Therefore, the present invention 11 should not be limited to the illustrations provided herein.

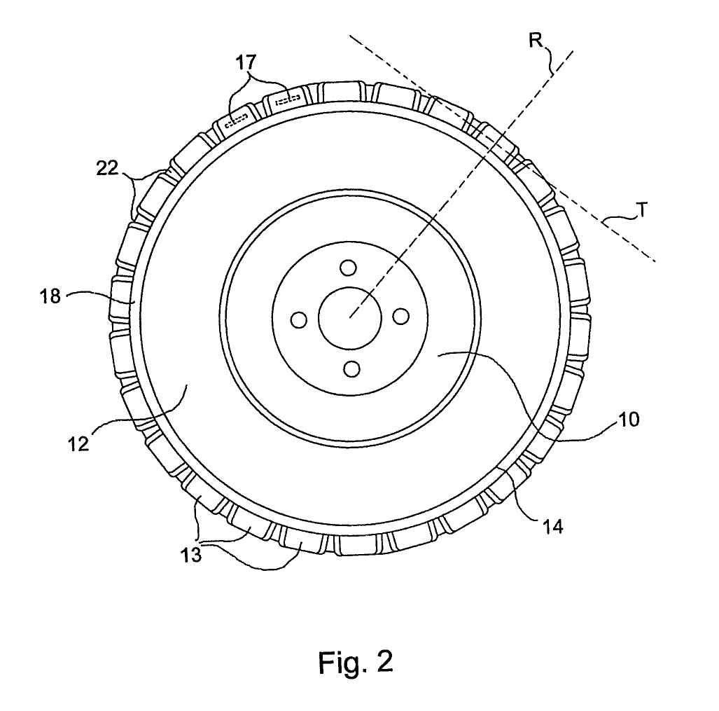

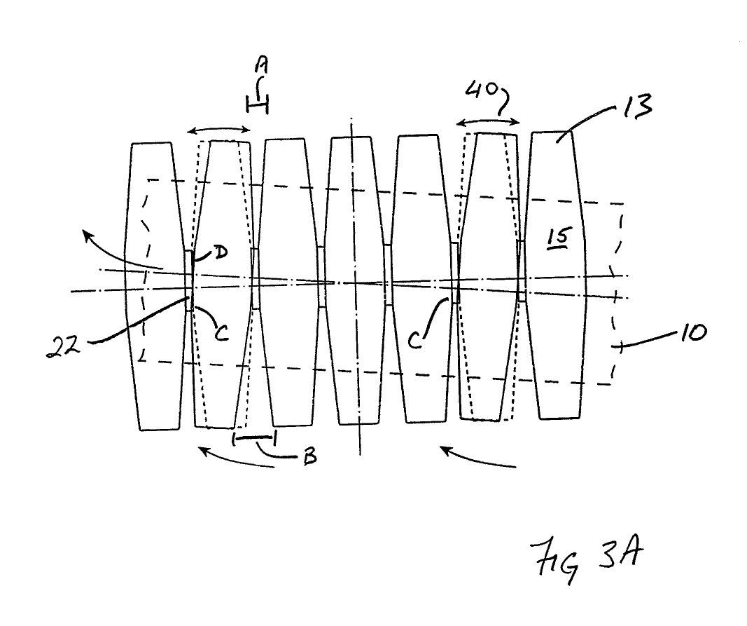

Now turning to FIGS. 2 and 5, each pad 13 is made of a resilient material, for example natural rubber or synthetic rubber or plastics material or other suitable resilient material, and preferably reinforced by a stiff reinforcing member 17 embedded therein and extending in the longitudinal direction of pad 13. Member 17 can be aluminium or any other suitable material that possess light weight and corrosion resistance characteristics.

Now returning to FIGS. 3 and 4, any suitable method to attached pads 13 to strip 18 is acceptable. For example, pads 13 can be secured to strip 18 by welding (including spot welding), soldering, brazing, or adhering or any other commercially available joining or coupling mechanism. One embodiment of ground engagement pad assembly 41 is shown in FIG. 5 illustrating strip 18 with pads 13 attached being secured to circumference 14 of tyre 12 by a rubber adhesive 20. Another embodiment of ground engagement pad assembly 41 can include pads 13 moulded integrally with the strip 18.

Ground engagement pad assembly 41 with strip 18 and attached pads 13 can be made long enough to fit round the entire circumference 14 of tyre 12. Alternatively, two or more shorter strips 18 can be used. Strip 18 can be joined end-to-end by welding, adhering, or any acceptable joining means as discussed above.

In addition to securing pads 13 to circumference 14 of tyre 12, the resilience of strip 18 permits each pad 13 at least a limited angle of rotational displacement about a substantially radial axis R (FIGS. 1, 2 and 5) of tyre 12, as indicated by the double-headed arrows A in FIG. 1. The resilience of strip 18 allows the tyre 12, and hence wheel 10 as a whole, to turn through the limited angle of rotation relative to any pad 13 currently in ground contact. Furthermore, the resilience of strip 18 ensures that each pad 13 is returned resiliently to its undisplaced or original position when pad 13has moved out of contact with the ground.

Alternatively, pads 13 can be directly attached to tyre 12 without interposing strip 18 where the resiliency of pads 13 and tyre 12 and the strength of the joint are sufficient to allow repeated angular displacements of pads 13.

Another embodiment of the present invention may include resilient buffers 22 disposed between adjacent pads 13. As best seen in FIG. 3A, when a turning motion is imparted to wheel 10, the ground-engaging pad 13 maintains its position. Upon further rotation of wheel 10, buffer 22 facilitates the realignment of the trailing pad 13 as it leaves the ground engaging condition and can also serve to facilitate the appropriate alignment of the subsequent ground-engaging pad 13. Thus, buffers 22 serve to more accurately control the correct dynamic alignment of the pads 13. This is achieved via a diagonally paired push/pull or torsion action (arrows 40) facilitated by the relevant buffers 22. The phantom image represents pads 13 in their ground engaging mode. As will be observed in the drawings, the distance “A” between two adjacent pads 13 gets smaller while the distance “B” gets larger. The presence of buffers 22 serve to restore the pads 13 to ‘normal’ non-grounding engaging dimensions when the relevant pads 13 are not longer ground engaging. The resilience of buffers 22 results in buffers 22 being in compression at “C” and tension at “D”.

Pads 13 can, if desired, also feature threads or studs or both on the outer surface 15 depending on the use of tyre 12. Furthermore, pads 13, buffers 22, resilient strip 18, reinforcing member 17, and tyre 12 can be of integral construction and manufactured accordingly.

Now returning to FIG. 5, the resilience of strip 18 and buffers 22 also permits each pad 13 at least a limited degree of tilting about an axis T substantially tangential to tyre 12, as indicated by the double-headed arrows 42. This can occur as present invention 11 moves across uneven ground. Again, each pad 13 is resiliently restored to a level position when pad 13 leaves the ground.

An alternative embodiment of the present invention incorporates tyre 12, pads 13, strip 18, and buffer 22 or combinations thereof into an integral component.

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

1. A tyre comprising:
a tyre portion adapted for mounting on to a vehicle wheel, said tyre portion including an outer surface; and
a plurality of pads being non-removably coupled onto said outer surface of said tyre portion without penetration through said outer surface of said tyre portion,
wherein each pad of said plurality of pads being capable of at least a limited angle of rotational displacement, in relation to the vehicle wheel, about a substantially radial axis of said tyre portion in response to rotation of the vehicle wheel,
whereby, said pad in contact with the ground is returned resiliently to its original position when said pad in contact has moved out of contact with the ground.

2. The tyre according to claim 1 further comprising a resilient strip interposed between said outer surface of said tyre portion and said each pad of said plurality of pads.

3. The tyre according to claim 1 further comprising a resilient block member interposed between adjacent pads of said plurality of pads, whereby said displaced pads are substantial returned to original non-grounding engaging dimensions when said displaced pad is no longer ground engaging.

4. A tyre comprising:
a tyre portion adapted for mounting on to a vehicle wheel, said tyre portion including an outer surface; and
a pad assembly attached to said outer surface of said tyre portion, said pad assembly including,
at least one elongated member, said at least one elongated member includes an upper surface and a bottom surface, said bottom surface being adapted for attachment to said outer surface of said tyre portion, and
a plurality of pads non-removably coupled to said upper surface of said at least one elongated member, wherein each pad of said plurality of pads being capable of at least a limited angle of rotational displacement in relation to the vehicle wheel about a substantially radial axis of said tyre portion in response to rotation of the vehicle wheel,
whereby, said pad in contact with the ground is returned resiliently to its original position when said pad in contact has moved out of contact with the ground.

5. The tyre according to claim 4 further comprising a plurality of resilient members interposed between adjacent pads of said plurality of pads, whereby said displaced pads are substantial returned to original non-grounding engaging dimensions when said displaced pad is no longer ground engaging.

6. The tyre according to claim 4 wherein each pad of said plurality of pads is further capable of at least a limited degree of tilting about an axis substantially tangential to said tire portion.

7. The tyre according to claim 4 wherein said plurality of pads are integral with said at least one elongated member.

8. The according to claim 5, wherein said a plurality of resilient members are integral with said at least one elongated member.

9. The tyre according to claim 4 wherein material used as said plurality of pads is selected from a group consisting of: natural rubber, synthetic rubber, polymers, and mixtures thereof.

10. The tyre according to claim 4 wherein material used as said at least one elongated member is selected from a group consisting of: natural rubber, synthetic rubber, polymers, and mixtures thereof.

11. The tyre according to claim 5 wherein material used as said plurality of resilient members is selected from a group consisting of: natural rubber, synthetic rubber, polymers, and mixtures thereof.

12. The tyre according to claim 4 wherein said at least one elongated member is attached to said outer surface of said tire portion by an adhesive.

13. The tyre according to claim 4 wherein each pad of said plurality of pads includes a relatively stiff reinforcing member embedded therein extending in the longitudinal axis of the pad.

14. The tyre according to claim 4 wherein said tyre is a pneumatic tyre.

15. A tyre comprising:
a tyre portion adapted for mounting on to a vehicle wheel, said tyre portion including an outer surface;
at least one elongated member, said at least one elongated member includes an upper surface and a bottom surface, said bottom surface being adapted for attachment to said outer surface of said tyre portion;
a plurality of pads;
a first coupling mechanism for fixedly coupling said plurality of pads to said upper surface of said at least one elongated member, wherein each pad of said plurality of pads being capable of at least a limited angle of rotational displacement in relation to the vehicle wheel about a substantially radial axis of said tyre portion in response to rotation of the vehicle wheel; and
a second coupling mechanism for fixedly coupling said bottom surface of said at least one elongated member to said outer surface of said tyre portion, wherein said second coupling mechanism does not penetration through said outer surface of said tyre portion,
whereby, a pad in contact with the ground is returned resiliently to its original position when said pad in contact has moved out of contact with the ground.

16. The tyre according to claim 15 wherein said first coupling mechanism is selected from the group consisting of: adhesive, welding, spot weld, brazing, soldering, and combinations thereof.

17. The tyre according to claim 15 wherein said second coupling mechanism is selected from the group consisting of: adhesive, welding, spot welding, brazing, soldering, and combinations thereof.

18. The tyre according to claim 15 further comprising a plurality of resilient members interposed between adjacent pads of said plurality of pads, whereby a rotationally displaced pad is substantial returned to its original non-grounding engaging position when said displaced pad is no longer ground engaging.

19. The tyre according to claim 15 wherein each pad of said plurality of pads includes a relatively stiff reinforcing member embedded therein extending in the longitudinal axis of the pad.

20. The tyre according to claim 1 wherein said tyre portion and said plurality of pads are integral.
